(19) United States
(12) Patent Application Publication
(10) Pub. No.: US 2026/0310199 A1
(43) Pub. Date: Oct. 8, 2026

(54) VEHICLE WITH BOUNDARY MAPPING AND EDITING SYSTEM

(71) Applicant: Deere & Company, Moline, IL (US)

(72) Inventors: Shriraam Prabu Subramanian, Pune (IN); Archita Nimesh Vakharia, Pune (IN); Neethu Mohan T, Pune (IN); Jacob J. Moellers, Aurora, IA (US); HANNA J. WICKMAN, Grimes, IA (US); Alisha N. Schwertner, Miles, TX (US); Kevin J. Synoga, Homer Glen, IL (US); Todd M. KARSTEN, Ankeny, IA (US); Meghna G. Roehl, West Fargo, ND (US)

(21) Appl. No.: 19/171,209

(22) Filed: Apr. 5, 2025

(51) Int. Cl. G05D 1/229; G05D 1/24; G05D 107/20; G05D 109/10; G05D 111/30

(52) U.S. Cl. CPC G05D 1/2297; G05D 1/24; G05D 2107/21; G05D 2109/10; G05D 2111/32

(57) ABSTRACT

A vehicle-based system for mapping and editing mapped boundaries of an controller and configured to receive position signals from a plurality of remote wireless transmitters. The controller is coupled to a memory, a display, and an operator input interface and can determine a current location of the vehicle using received position signals which the controller can store in memory and map on the display as boundary points as an operator drives the vehicle along a track. Controller can also store in memory and display a preexisting map of the perimeter of an area of land overlain with the boundary points and can use the boundary points to edit the preexisting map.

### FIELD OF THE DISCLOSURE

The present disclosure relates generally to a vehicle-based system and method for mapping and editing mapped boundaries of an area of land and, more specifically, to a vehicle-based system for editing mapped boundaries using receiver configured to receive position signals from a plurality of remote wireless transmitters.

### BACKGROUND

Drivers and vehicle operators have used mapping systems mounted on vehicles to map boundaries of areas of land. Such vehicle mounted systems receive position signals from remote wireless transmitters to determine and record the position of the vehicle as the operator drives the vehicle around the boundary of the area of land being mapped. Generally, the operator begins mapping at a starting point along the boundary and drives the vehicle around the entire area of land, returning to the starting point. When the vehicle returns to the starting point and the recorded boundary of the area of land forms a closed shape, the operator may determine that the mapping is completed and can store the complete mapped boundary in memory. However, the quality of the position signals can vary due to environmental effects. For example, trees, buildings, or other obstacles may interrupt or block, the path of the position signals the system receives from the transmitters. Loss of signal quality can degrade the accuracy of the position determination and render sections of the mapped boundary unsuitable for certain applications such as when used by autonomous farm vehicles to navigate fields for spraying, plowing, or harvesting. Indeed, when mapping a boundary, operators may come across obstacles, such as trees, large rocks, or other features of the terrain that the operator must drive around to avoid with the mapping vehicle. The resulting mapped boundary in those areas may result in a boundary shape that is unsuitable or impractical for to be driven by a farm vehicle, such as a tractor pulling a plow or sprayer, that will later be using the map to navigate. The useable area of land may also change shape due to such factors as purchase or sale of portions of the land area, changing path of roads, and erosion, for example. Present systems require an operator to remap the entire boundary increasing the cost and time spent mapping. Therefore, there is a need for a vehicle-based system and method for editing mapped boundaries of an area of land so that operators can identify low quality or inaccurate portions of mapped boundaries and remap those portions without having to remap entire boundaries.

### SUMMARY OF THE DISCLOSURE

One embodiment directed to a system for editing and mapping a boundary using a vehicle can include a vehicle configured to traverse a path along a ground surface at a controllable speed and direction. The vehicle can have a reference point at a first position and a console configured to receive operator commands to control the speed and direction with which the vehicle traverses the ground surface. A receiver can be mounted at a second position on the vehicle, wherein the receiver is configured to receive from each of a plurality of remote wireless transmitters a corresponding position signal, and wherein the receiver is configured to generate a location signal in response to the received position signals. A controller having a memory and communicatively coupled to a display, to an input interface, and to the receiver, can be configured to determine a location of the reference point using the location signal from the receiver and to generate boundary points. The boundary points can include an initial boundary point and subsequent boundary points. Each subsequent boundary point can be generated at a predetermined interval following the previous boundary point. Each boundary point represents the determined location of the reference point as the vehicle traverses the path. The controller can further be configured to store a first set of boundary points in the memory. In response to an undo command received from the input interface, identify a closest nearby set of consecutively stored boundary points in the first set as an overwrite set of boundary points and an overwrite start point. In response to a resume command received from the input interface, the controller stores in memory a second set of boundary points as the vehicle traverses the ground surface and replaces the overwrite set of boundary points stored in memory with the second set of boundary points. The predetermined interval can be a time period of 1 second or less or a distance of 5 meters or less that the vehicle has travelled along the path.

According to one aspect, the controller can be configured to display on the display a point representing a current determined location of a position of the vehicle, the first set of boundary points, the overwrite set of boundary points, and the second set of boundary points. The point representing a determined location of a position of the vehicle can be the first position or the second position. According to another aspect, the input interface can be integrated into the display. According to a further aspect, the controller can be configured to determine the location of the reference point by calculating a receiver position using the location signal and calculating the location of the reference point by offsetting the receiver position by the distance and direction separating the first position from the second position.

A second embodiment can be directed to a method for editing and mapping a boundary. The method includes providing a vehicle configured to traverse a path along a ground surface at a controllable speed and direction. The vehicle can have a reference point at a first position and a console configured to receive operator commands to control the speed and direction of the vehicle along the ground surface. The method further includes providing a receiver mounted at a second position on the vehicle, wherein the receiver is configured to receive from each of a plurality of remote wireless transmitters a corresponding position signal, and wherein the receiver is configured to generate a location signal in response to the received corresponding position signals. The method also includes providing a controller having a memory and communicatively coupled to a display, to an input interface, and to the receiver.

The controller is configured to perform the steps of determining a location of the reference point using the location signal from the receiver and generating boundary points including an initial boundary point and subsequent boundary points. Each subsequent boundary point generated at a predetermined interval following the previous boundary point, wherein each boundary point represents the determined location of the reference point as the vehicle traverses the path. The controller is further configured to perform the steps of storing a first set of boundary points in the memory. In response to an undo command received from the input interface, controller performs the steps of identifying a closest nearby set of consecutively stored boundary points in the first set as an overwrite set of boundary points and an overwrite start point.

In response to a resume command received from the input interface, the controller is configured to perform the steps of storing in memory a second set of boundary points as the vehicle traverses the ground surface and replaces the overwrite set of boundary points stored in memory with the second set of boundary points. The predetermined interval can be a period of 1 second or less or a distance along a path traversed by the vehicle of 5 meters or less.

According to one aspect of this embodiment the controller can be configured to perform the step of displaying on the display a point representing a current determined location of a position of the vehicle, the first set of boundary points, the overwrite points, and the replacement points. The point representing a determined location of a position of the vehicle can be the first position or can be the second position. Optionally the controller can be configured to perform the step of integrating input interface into the display. As a further option, the controller can be configured to perform the step of determining the location of the reference point by calculating a receiver position using the location signal and calculating the location of the reference point by offsetting the receiver position by and offset distance and direction separating the first position from the second position.

A further embodiment directed to a system for editing and mapping a boundary using a vehicle can include a vehicle configured to traverse a path along a ground surface at a controllable speed and direction. The vehicle can have a reference point at a first position and a console configured to receive operator commands to control the speed and direction with which the vehicle traverses the ground surface. A receiver can be mounted at a second position on the vehicle, wherein the receiver is configured to receive from each of a plurality of remote wireless transmitters a corresponding position signal, and wherein the receiver is configured to generate a location signal in response to the received position signals. A controller having a memory and communicatively coupled to a display, to an input interface, and to the receiver, can be configured to determine a location of the reference point using the location signal from the receiver and to generate boundary points. The boundary points can include an initial boundary point and subsequent boundary points. Each subsequent boundary point can be generated at a predetermined interval following the previous boundary point. Each boundary point represents the determined location of the reference point as the vehicle traverses the path. The controller can further be configured to store a set of boundary points in the memory as well as store a first set of perimeter points in the memory. The first set of perimeter points represents a closed shape of an area of land.

In response to receiving a record command received from the input interface, the controller stores a set of boundary points in memory, including the initial boundary point and an end boundary point. The controller in addition identifies a first point of intersection and a second point of intersection between the set of boundary points and the first set of perimeter points as well as a set of partition boundary points between the first point of intersection and second point of intersection. In response to a select command received from the input interface, the controller stores in memory a second set of perimeter points representing points in the first set of perimeter points and the partition boundary points that border a selected region. The predetermined interval can be a period of less than 0.5 seconds or a distance of 5 meters or less along the path.

Optionally, the controller can be configured to display on the display a point representing a current determined location of a position on the vehicle, the first set of perimeter points, and the set of boundary points. The point representing a determined location of a position on the vehicle can be the first position or the second position. According to a further option, the controller can be configured to display on the display a first region and a second region bounded by the first set of perimeter points and the set of boundary points, and wherein the selected region is either the first region or the second region. According to one alternative, the set of boundary points can bisect the first set of perimeter points. According to another alternative, the set of boundary points can define an external region contiguous to the region defined by the first set of perimeter points. According to yet another option, the controller can be configured to determine the location of the reference point by calculating a receiver position using the location signal and calculating the location of the reference point by offsetting the receiver position by an offset distance and direction separating the first position from the second position.

Another embodiment is a method for editing and mapping a boundary using a vehicle. The method can include providing a vehicle configured to traverse a path along a ground surface at a controllable speed and direction, the vehicle having a reference point at a first position and a console configured to receive operator commands to control the speed and direction of the vehicle along the ground surface. The vehicle can include a receiver mounted at a second position on the vehicle. The receiver can be configured to receive from each of a plurality of remote wireless transmitters a corresponding position signal, and wherein the receiver is configured to generate a location signal in response to the received corresponding position signals. The vehicle can also include a controller having a memory and communicatively coupled to a display, to an input interface, and to the receiver.

The controller can be configured to determine a location of the reference point using the location signal from the receiver and to generate boundary points including an initial boundary point and subsequent boundary points. Each subsequent boundary point is generated at a predetermined interval following a previous boundary point. in addition, each boundary point represents the determined location of the reference point as the vehicle traverses the path. The controller can further be configured to store a first set of perimeter points in the memory, the perimeter points representing a closed shape of an area of land. In response to receiving a record command from the input interface, the controller stores a set of boundary points in memory, including the initial boundary point and an end boundary point. The controller further identifies a first point of intersection and a second point of intersection between the set of boundary points and the first set of perimeter points, and a set of partition boundary points between the first point of intersection and second point of intersection. In response to a select command received from the input interface, the controller stores in memory a second set of perimeter points representing points in the first set of perimeter points and the partition boundary points that border a first selected region. The predetermined interval can be a period of less than 0.5 seconds or a distance along a path traversed by the vehicle of 5 meters or less.

According to one alternative, the controller can be configured to display on the display a first region and a second region bounded by the first set of perimeter points and the set of boundary points, and wherein the selected region is either the first region or the second region.

According to yet another embodiment, a system for editing and mapping a boundary using a vehicle can include a vehicle configured to traverse a path along a ground surface at a controllable speed and direction. The vehicle can include a reference point at a first position and a console configured to receive operator commands to control the speed and direction of the vehicle along the ground surface. The vehicle can also include a receiver mounted at a second position on the vehicle, wherein the receiver is configured to receive from each of a plurality of remote wireless transmitters a corresponding position signal, and wherein the receiver is configured to generate a location signal in response to the received corresponding position signals. In addition, the vehicle can include a controller having a memory and communicatively coupled to a display, to an input interface, and to the receiver. The controller is configured to determine a location of the reference point using the location signal from the receiver and to generate boundary points. The boundary points include an initial boundary point and subsequent boundary points. Each subsequent boundary point is generated at a predetermined interval following a previous boundary point, wherein each boundary point represents the determined location of the reference point as the vehicle traverses the path. The controller is further configured to store a set of perimeter points in the memory. In response to receiving a record command received from the input interface, the controller is also configures to replace in memory a plurality of perimeter points in the set of perimeter points with a plurality of generated boundary points.

### BRIEF DESCRIPTION OF THE DRAWINGS

FIG. 1 is a left side view of one embodiment of a vehicle for mapping and editing a mapped boundary of an area of land.

FIG. 2 is a top view of the interior of one embodiment of a cab suitable in the vehicle of FIG. 1.

FIG. 3 is a top schematic view of one embodiment of the vehicle of FIG. 1.

FIG. 4 is a schematic diagram of an embodiment of a mapping and editing system suitable for the vehicle of FIG. 1.

FIG. 5A and FIG. 5B are flow charts showing the steps for mapping and editing a mapped boundary using the vehicle of FIG. 1.

FIGS. 6A, 6B, 6C, 6D, and 6E, are views of one embodiment of an operator interface showing information displayed and input devices presented for operation of the vehicle of FIG. 1.

FIG. 7 is one view of a second embodiment of an operator interface showing information displayed and input devices presented for operating the vehicle of FIG. 1 to edit an existing boundary.

FIG. 8 is a second view of a second embodiment of an operator interface showing information displayed and input devices presented for operating the vehicle of FIG. 1 to edit an existing boundary.

FIG. 9 is a third view of a second embodiment of an operator interface showing information displayed and input devices presented for operating the vehicle of FIG. 1 to edit an existing boundary.

FIG. 10 is a flow chart showing the steps for mapping and editing an existing mapped boundary using the vehicle of FIG. 1.

### DETAILED DESCRIPTION

A vehicle for mapping and editing a boundary of an area of land can be a vehicle having a mapping and editing system. The vehicle can be controlled and maneuvered by an operator to drive across the land surface following the boundary. The vehicle preferably includes a reference point fixed at a first position. While driving, the operator maneuvers the vehicle so that the reference point follows the boundary as closely as possible. Thus, the land boundary and reference point both preferably remain in view of the operator so that the operator can readily control the vehicle so that the reference point follows the land boundary accurately. Using wireless signals received by a receiver fixed at a second position on the vehicle (the receiver position), the mapping and editing system determines the geographic location of the receiver position. The reference point can be at a different position on the vehicle from the receiver position or alternatively, depending on the design of the vehicle, an operator can conveniently use the receiver position as the reference point. Thus, the first position can be a different from the second position and separated by an offset, or they can represent the same position if the operator uses the receiver position as the reference point. By considering the offset between the receiver position and the reference position, the mapping and editing system can determine the reference position as the operator drives the vehicle follows the boundary with the reference point.

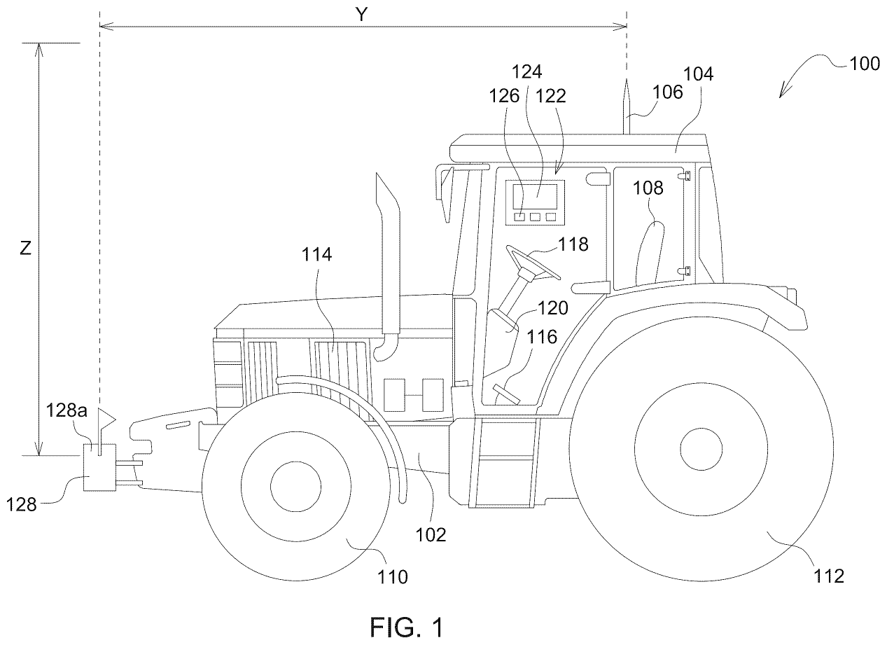

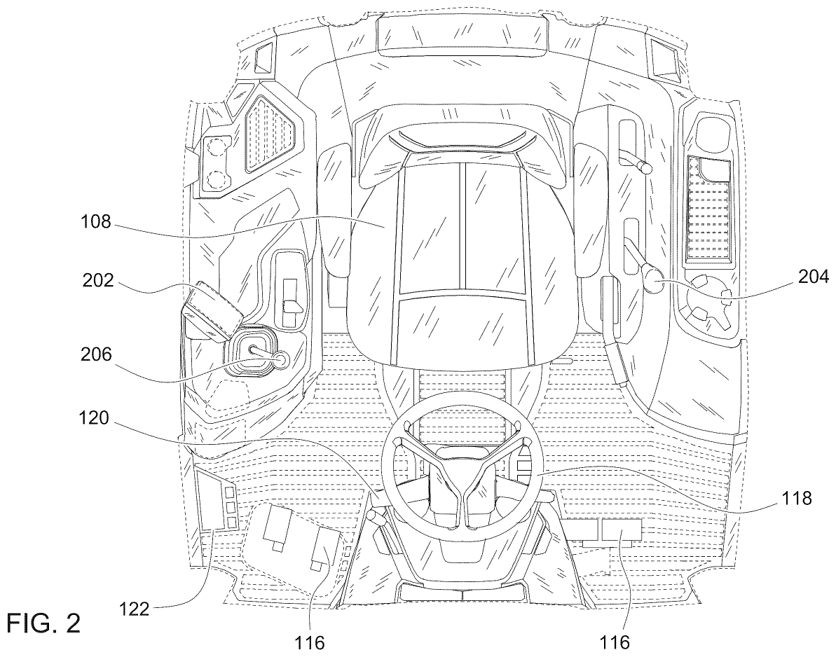

Various types of wheeled or tracked vehicle can be suitable for mapping and editing the land boundary, providing the vehicle is sufficiently controllable and maneuverable to follow the land area's terrain, such as agricultural tractors, automobiles, trucks, all-terrain vehicles, and utility terrain vehicles. FIG. 1 is a left side view of one embodiment of an agricultural tractor which is one type of suitable vehicle. Tractor 100 includes a frame 102 supported on a pair of steerable front wheels 110 and a pair of rear wheels 112. While wheels are described in the embodiments, other ground engaging traction devices, including tracks, are contemplated. Tractor 100 can include an engine 114 as the prime mover and power source for operating the tractor. Engine 114 can be coupled to drive wheels 110, 112 to propel tractor 100 over the ground surface of the land area. Engine 114 can also be connected to mechanically drive ancillary equipment, such as via a power take off (PTO), connected to pumps to hydraulically power ancillary equipment such as hydraulic actuators and motors, and connected to generators or alternators to electrically power ancillary equipment, such as mapping systems, electronic controllers, and sensors. Operator cab 104 is mounted on the frame 102 and includes a seat 108 from which an operator can manipulate various levers, switches, pedals, joysticks, a steering wheel or similar controls with which an operator and control and operate various tractor functions and features. FIG. 2 is a top view of the interior of operator cab 104 according to one embodiment.

For example, operator cab 104 can include one or more consoles 120 with input devices such as steering wheel 118 and accelerator, propel, clutch and/or brake pedals 116 that an operator can manipulate to control the speed and direction that tractor 100 travels. The operator commands tractor 100 to travel or maneuver in a desired direction and speed by manipulating steering wheel 118 or pedals 116. Operator cab 104 can additionally include one or more joysticks and levers 204, 206 to control such as a PTO as well as the operation and movement of ancillary devices such as hydraulic implements. Operator cab 104 can further include operator interfaces 122, 202 through which an operator can receive information about the operation of the tractor 100 through displays and dials and, optionally, input commands to control the operation of other tractor functions and features such as a boundary mapping and mapped boundary editing system. Operator interface 122 can include a display 124 for displaying information to the operator, as well as operator interface input devices 126, such as buttons, levers, dials, and switches through which an operator can input commands. As is known, operator interface input devices 126 can be implemented as mechanical buttons and/or other input devices or can be implemented as software-defined areas on a touch screen display or can be physical buttons programmed to issue different commands depending on contextual information shown in display 124. The operator interface 122, in one embodiment, includes display 124 having a plurality of operator selectable buttons to select from a plurality of commands or menus, each of which are selectable through a touch screen having a display. In another embodiment, the operator interface includes a plurality of mechanical push buttons as well as a touch screen. In another embodiment, the user interface includes a display screen and only mechanical push buttons.

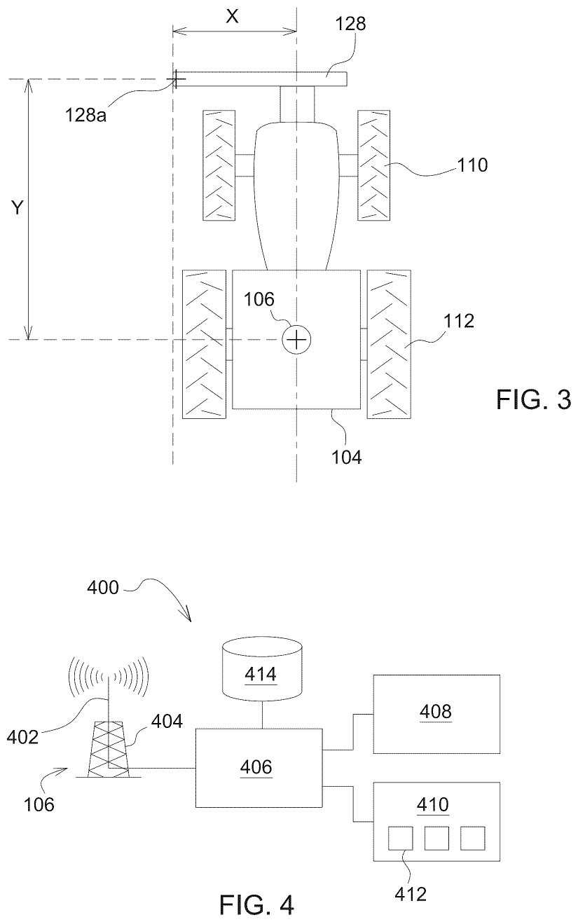

As shown in FIGS. 1 and 3, tractor 100 can include a wireless receiver 106 mounted at a receiver position, such as on the roof of cab 104. Tractor 100 can also include a reference bar 128 having a reference point 128a that is preferably visible from an operator's seated position in cab 104. Reference point 128a is preferably a point on the vehicle that the operator uses to indicate the location of the border. However, in some embodiments, reference point 128a can be an imaginary or virtual point at a specified distance and direction from the receiver position. To avoid obstacles while driving the border and the need to drive the vehicle outside the border, reference point 128a can preferably be located on reference bar 128 such that reference point 128a is the closest point on tractor 100 to the border. Reference point 128a can preferably be positioned to be clear of portions of tractor 100, such as wheels 110, 112, operator cab 104, towed implements, or structures projecting from tractor frame 102 that could strike and damage, or obstruct from the operator's view, border posts, fences, and other border markers as the operator maps the border. Reference point 128a is located at a first position offset by a longitudinal distance y, a transverse distance x, and a vertical distance z from the receiver position, where receiver 106 is mounted. The combined longitudinal distance, transverse distance, and vertical distance is the XYZ offset. Thus, the position of reference point 128a relative to the receiver position can be determined by offsetting the position of receiver 106 by the XYZ offset.

As shown in FIG. 4, wireless receiver 106 can be communicatively coupled to a controller 406 as part of a border mapping and mapped border editing system 400. Wireless receiver 106 is preferably designed to receive position signals from remote wireless transmitters. The remote wireless transmitters can be airborne, carried on satellites or mounted terrestrially and wirelessly transmit information in signals that appropriately configured wireless receivers can use to determine the geographical location of the receiver. As is known, position signals can be wirelessly transmitted using various types of signals or waves such as light, infrared, laser, radio waves and microwaves. Wireless receiver 106 can include a suitable transducer for detecting wireless signals such as antenna 402 communicatively coupled to a signal receiving device 404 which can amplify, condition, and extract the information transmitted in the signal. A position signal received from a remote wireless transmitter can include, for example, information regarding the position of the transmitter and its distance from the receiver's antenna 402. Signal receiving device 404 can receive position signals from multiple remote wireless transmitters and use the information in each of position signals received from the multiple transmitters to determine the location of antenna 402 and, thus, tractor 100. For example, one known technique used in Global Positioning Systems (“GPS”) to calculate location, velocity and elevation of a receiving antenna is called trilateration. Wireless receiver 106 can also receive information associated with the position signals that can be used by the signal receiving device 404 or controller 406 to assess the strength, quality, repeatability, and accuracy of the position signals. In response to receiving a position signal, signal receiving device 404 can transmit a location signal to controller 406. The location signal can include information regarding the current geographic location of the wireless receiver 106 or its antenna 402 at the time the position signal was received as well as metadata regarding the quality, repeatability and accuracy of the position signal or the current geographic location, metadata relating to the type of transmitter, receiver, position signal and algorithms used to calculate location. The quality, repeatability, and accuracy can depend on the characteristics of the received position signal as well as the sensitivity and accuracy of the signal receiving device 404, antenna 402, and algorithms used by controller 406 or receiving device 404 to calculate the geographic location from the position signal or location signal.

Controller 406 is coupled to receive the location signal from signal receiving device 404 and to receive operator commands from input devices 412, such as buttons, levers, dials, and switches which can be part of input operator interface 410 and through which an operator can input commands. Controller 406 is also communicatively coupled to store and retrieve data and information in memory 414 and communicatively coupled to display information and data so the data and information are viewable by an operator on display 408. Memory 414 can include short term memory, such as random access memory, and can include long term memory such as read only memory, or other storage devices such as disk drives, memory tapes, or memory chips. Tractor 100 can include other communication receivers and transmitters in addition to wireless receiver 106 that permit tractor 100 and optionally controller 406 to transmit and receive data and information via other networks such as via cellular telephone networks, Bluetooth networks, and Wi-Fi networks. Controller 406 can optionally communicate with such networks to download to controller 406 or memory 414 contextual maps of the land area surrounding tractor or to upload to such networks information regarding the operation and position of tractor 100, and the like. Controller 406 can be configured to display contextual maps of the of the area of land in the vicinity of tractor 100 and to periodically download updates to the contextual map as tractor changes position when driven. Controller can be configured to request updated contextual maps based on the current determined location of tractor 100 and can also overlay onto such contextual maps the current determined location of tractor 100 or, more specifically, the determined location of receiver position and/or the reference point. As a further option, controller 406 can be configured to overlay onto such contextual maps a line or a set of points representing the tractor's previous determined locations showing the path the tractor 100 has traversed while driven by the operator. Controller 406 can also be configured to display information regarding the quality, accuracy, and repeatability of the position signal, location signal, or determined location.

Controller 406 can include a processor coupled to a memory and can be configured by a program or code stored in the memory to perform steps specified in the program or code. According to one embodiment, controller 406 can include code that configures controller 406 to determine the current location of antenna 402 of receiver 106 using the location signal from receiving device 404. Controller 406 can also determine the location of reference point 128a by offsetting the current location of antenna 402 of receiver 106 by the XYZ offset.

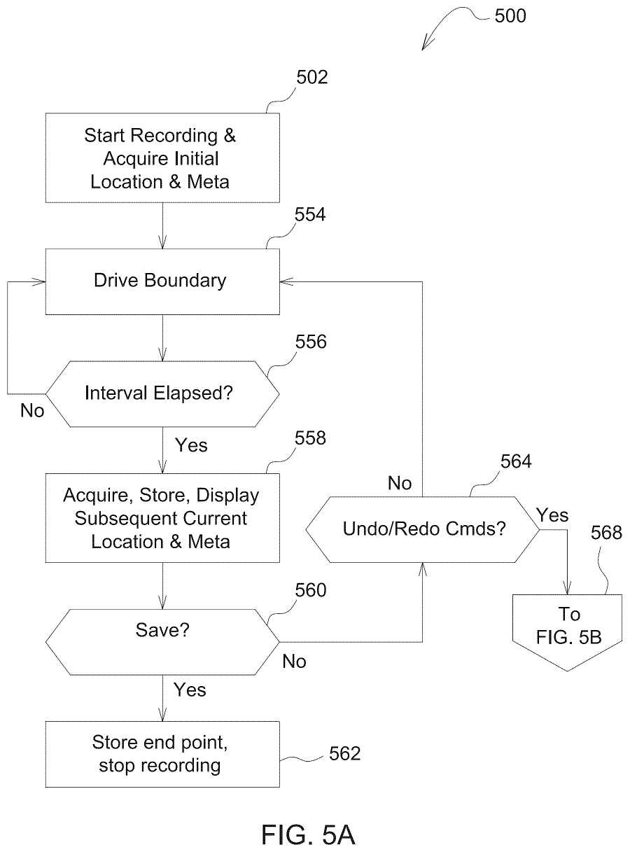

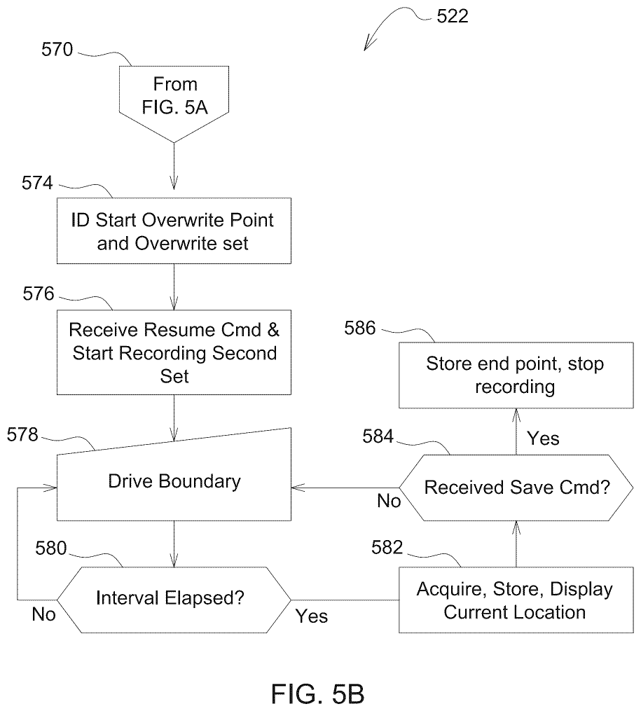

A first part 500 and a second part 522 of a flow chart showing the steps an operator can perform in tractor 100 to map and edit a mapped boundary is shown in FIGS. 5A and 5B, respectively. In an initial step 502, controller 406 can be configured to receive a command from operator input interface 410 to start recording the driven path of tractor 100. Preferably, before initiating this command, the operator will have driven tractor 100 to a starting point at the boundary of the area of land to be mapped so that the reference point 128a is aligned with the boundary starting point. Additionally, the operator will have adjusted the position of reference point 128a to extend beyond the other extremities of tractor 100 as shown in FIG. 4 and will have stored the measured XYZ offset in memory 414 associated with controller 406. Thus, on receiving the start recording command, controller 406 calculates the current determined location of reference point 128a, which represents the starting location, stores the reference point's starting location and metadata in memory 414 as the first boundary point, and displays the starting location overlaid on a contextual map showing the tractor 100 and its vicinity on display 408. Controller 406 detects when the current location of tractor 100 begins to change when the operator begins driving the boundary. As the operator drives along the boundary in step 554, constantly aligning reference point 128a with the boundary line, at step 556 controller 406 periodically checks whether a predetermined interval has elapsed. This interval can be an elapsed time or an elapsed distance since the controller calculated and/or stored the previous reference point's current determined location. If the interval is based on a time period, the interval is preferably less than 1 second. However, such an interval can be 0.5 seconds or 0.2 seconds or less, for example. The time interval can be a preset fixed interval stored in the controller's memory. Alternatively, the interval can be an adjustable time interval that an operator can adjust. As a further alternative, controller 406 can adjust the time interval based on the quality of signal, the speed at which operator drives tractor 100, or based on other operational parameters, such as the distance the tractor has travelled since storing the previous boundary point in memory. The interval can also be a distance tractor 100 travels, such as less than 1 meter or, preferably, 0.5 meters or less, or even more preferably, 0.2 meters or less. If the interval has elapsed, in step 558, controller 406 calculates the new current determined location for reference point 128a using current location signal, stores the new reference point current determined location and metadata in memory as a subsequent boundary point, and updates display 408 to show the overlay of the tractor path including the additional new current determined location of the subsequent boundary point. Controller 406 may also display metadata associated with the boundary point to assist the operator in assessing the quality, accuracy, and repeatability of the data point. For example, the controller may change the color or shape of the point depending on signal quality and location accuracy. Controller may also be configured to display a series of consecutive points as a continuous line of a color dependent on the accuracy or quality of underlying points. Controller could display the line as a different type (such as solid, dotted, or dashed) depending on the distance between the most recent boundary point and the starting location. Thus, a dotted line could indicate that the boundary point is far from the starting location, while a solid line could indicate that the boundary point and the starting location are close or proximate.

As part of step 558, after determining that tractor 100 has driven a minimum interval since receiving the start recording command, controller 406 compares the new current determined location for the reference point 128a with the starting location to determine whether the current determined location is proximate to, or nearby, the starting location. Controller 406 can perform this step by determining whether the distance between starting location a current determined location is less than 5 meters or, preferably, less than 0.5 meters or, even more preferably, less than 0.2 meters and is therefore proximate. If the controller 406 calculates that the distance between the starting location and the current determined location is small and, therefore the starting location is proximate to the current determined location, controller 406 determines that the tractor has mapped a closed shape and has now completed mapping of the selected area of land. Controller 406 then alerts the operator by appropriately adjusting display 408 In step 560 controller 406 queries whether it has received a Save command through input devices 412. If controller 406 has received a save command, in step 562, controller 406 stores the current determined location of the reference point and associated metadata as the boundary end point (the last driven point acquired) and stops recording. However, if in step 560 controller 406 determines that no Save command has been received, controller in step 564 queries whether it has received an Undo, or Redo command.

If in step 564 controller 406 determines that it has not received an Undo, or Redo command it next goes to step 554 and continues to record reference point location data and metadata as operator drives tractor 100. However, if controller 406 determines that it has received such a command, it goes on via steps 568 and 570 to step 574. The Undo and Redo commands permit an operator to edit a set of determined location points that have been stored in memory 414 and mapped on display 408.

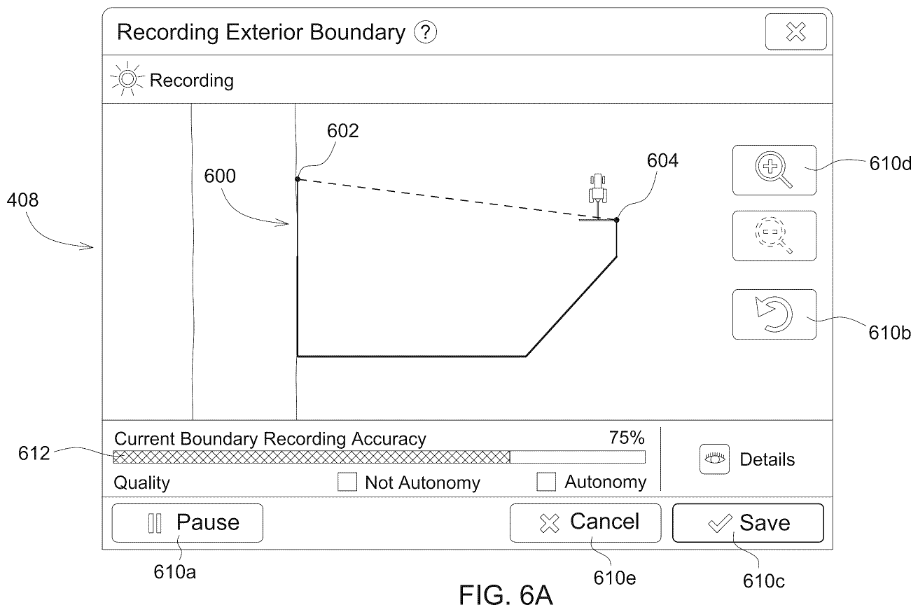

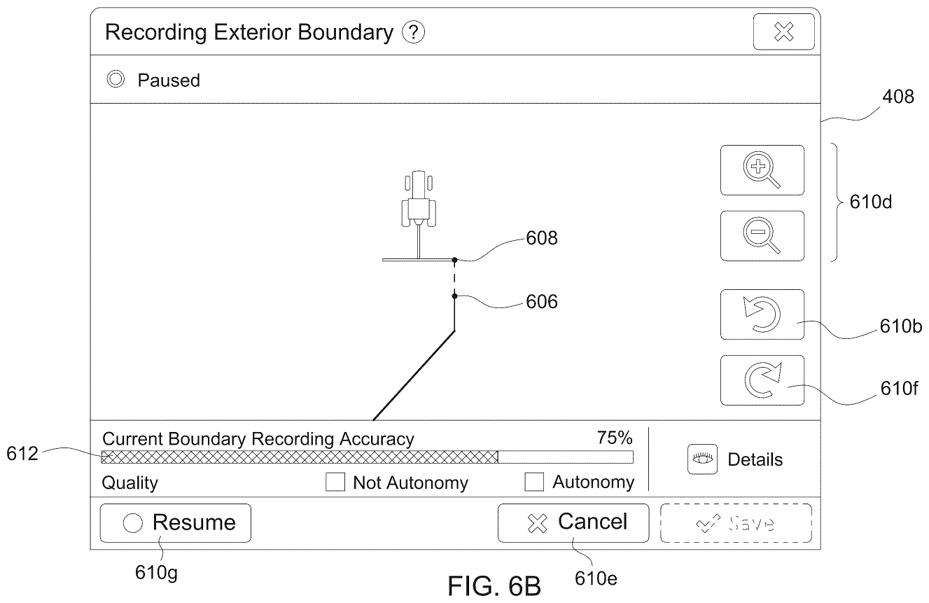

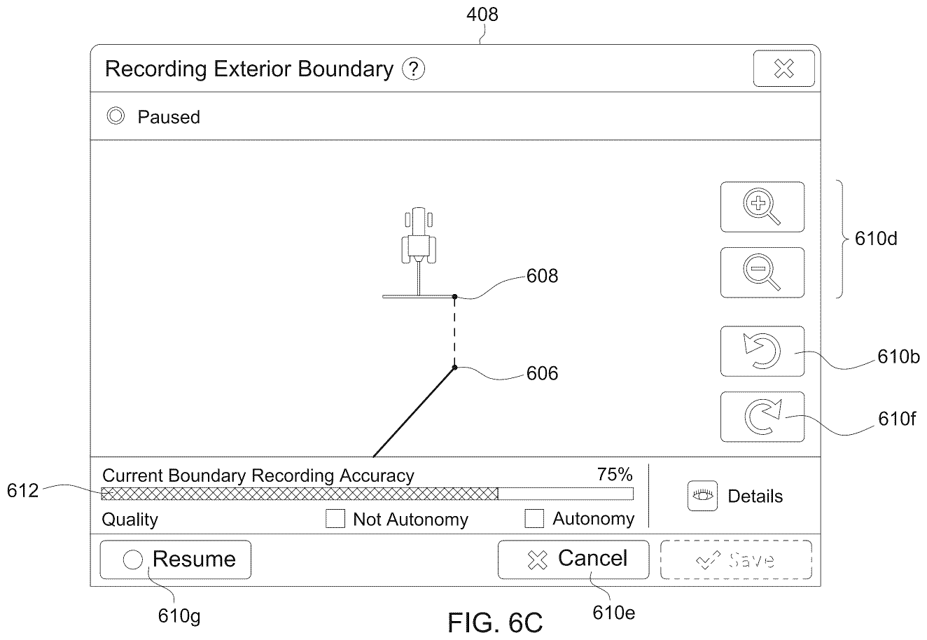

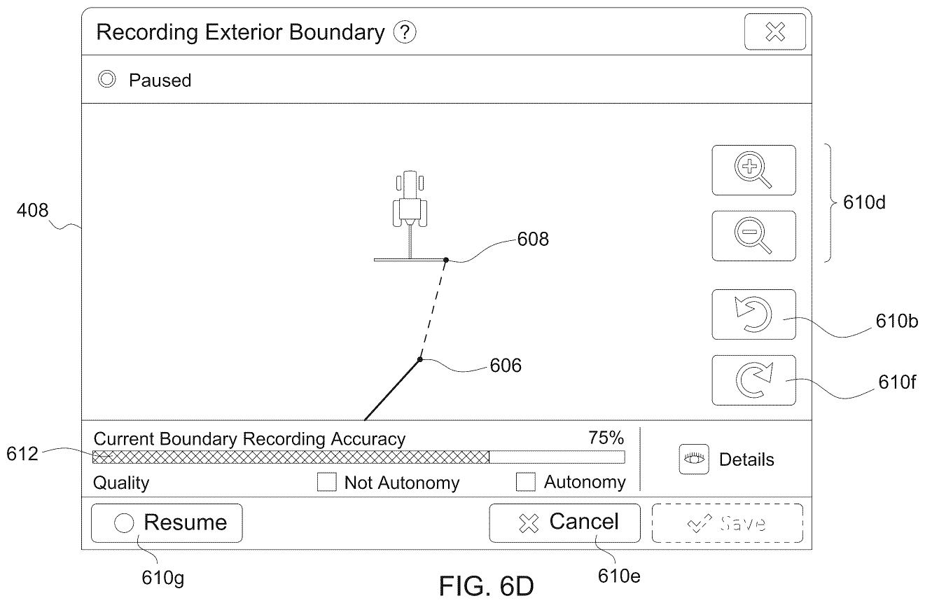

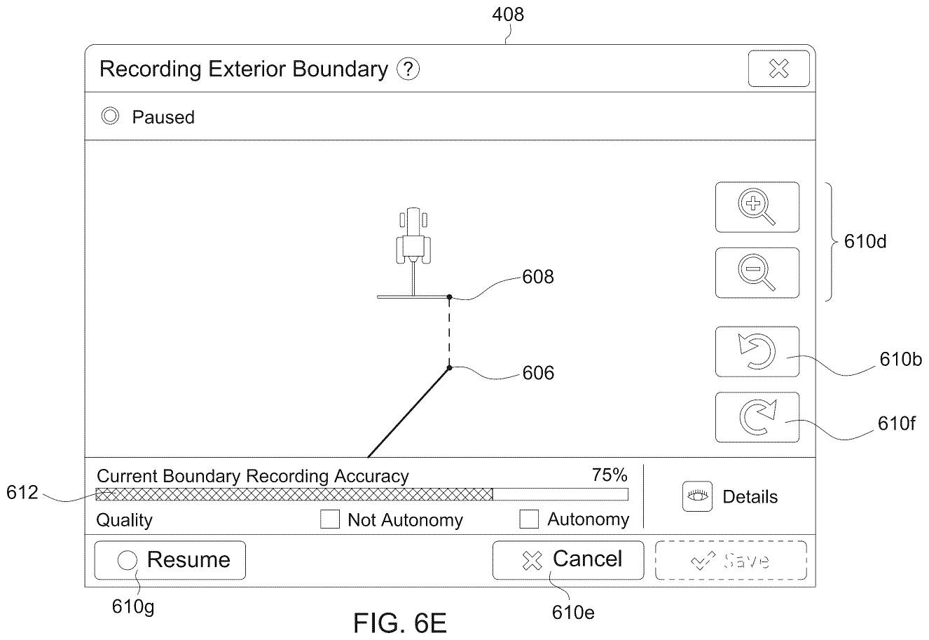

FIG. 6A depicts one embodiment showing how controller 406 can configure input devices 412 in operator input interface 410. FIG. 6A is a touch screen display 408 presenting input devices 412 displayed as Pause 610a, Undo 610b, Save 610c, Zoom 610d, and Cancel 610e buttons which controller 406 integrates into the display 408 of the mapped path 600 of reference point 128a as operator drives tractor 100 to follow the land boundary. Boundary start location is shown by a first dot 602 and the current determined location of reference point 128a is shown by a second dot 604. The mapped path 600 can be displayed using different line or point types or colors to indicate signal quality or position accuracy to assist the operator identify which portions of the mapped boundary to edit or remap by overwriting saved or mapped points. Optionally controller 406 can be configured to display a separate signal quality bar graph 612 indicating signal quality or boundary point accuracy. The mapped path 600 represents a first set of stored currently determined locations of reference point 128a. Operator inputs the Undo command to edit the stored and mapped boundary points of the driven boundary.

The Pause command temporarily stops controller 406 from recording (i.e., the controller stops storing and mapping the reference point's current determined location) and permits an operator to drive tractor 100 and reposition it without recording. When the operator issues the Pause command by pressing the pause button 610a, shown in FIG. 6A, the resume button 610g appears as shown in FIG. 6B to permit the operator to restart recording whenever desired.

Controller 406 can receive Undo/Redo commands that an operator inputs by pressing Undo button 610b and/or Redo button 610f, as shown in FIGS. 6A, 6B. Pressing Undo button 610b pauses recording and causes controller 406 to display Resume button 610g. An initial Undo command causes controller 406 to identify a most recent set of boundary points that the controller stored in memory as tractor 100 has most recently driven a predetermined distance along the boundary. In one embodiment, for example, the Undo command causes controller 406 to identify those points in the first set stored during the last 5 meters of the tractor's travel. The controller identifies these first set boundary points in the as an overwrite set of boundary points as they are points selected to be overwritten during the editing process. With each subsequent press of the Undo button 610b, controller 406 identifies the next closest nearby set of consecutively stored boundary points in the first set as an overwrite set of boundary points. Optionally, as shown in FIG. 6B, controller 406 can change the appearance of the displayed path to indicate the portion of the displayed path which is in the overwrite set. Controller 406 identifies an overwrite start point, which is stored boundary point 606, as well as the overwrite set, which includes all stored boundary points represented by the deleted portion of the solid line from boundary point 606 to point 608. Optionally, controller 406 can be configured so that each press of the Undo command identifies at least all the stored points within 5 meters of the previous stored boundary points in mapped path 600. As shown in FIGS. 6C and 6D, additional presses of the Undo button can identify additional sets of stored boundary points to include in the overwrite set (for example additional 5 m sections of the driven path shown by the deletion of additional lengths of solid line in FIGS. 6C and 6D). Pressing the Redo button 610f can conversely remove consecutive points wrongly added to the overwrite set. FIG. 6D depicts the display after an operator has pressed the Redo button 610f. FIG. 6E, shows the resulting additional length of the dotted solid line which indicates the smaller set of overwrite points to be deleted.

The overwrite set includes a furthest stored boundary point 606 from the tractor's current location along the tractor's driven path. The overwrite set also includes a nearest stored boundary point 608 from the tractor's current location along the tractor's driven path, which can be the last stored boundary point before the operator issued the pause command. According to one embodiment, to begin editing the stored boundary points in the overwrite set, the operator drives tractor 100 to the overwrite start point which is the furthest stored boundary point 606 in the overwrite set. In step 576, controller 406 receives a Resume command when it detects the operator has pressed Resume button 610g. Controller 406 can, optionally, delete overwrite set of boundary points from the first set and begin recording the reference point's current determined locations and metadata as a second set of boundary points. Alternatively, controller can retain the overwrite set of boundary points, separately store the new, second set of boundary points generated after receiving the Resume command, and replace the overwrite set with the second set when mapping is completed.

FIG. 6E shows an operator pressing the Resume button. In step 578, operator drives tractor 100 to follow the boundary from the overwrite start point. With recording resumed, in step 580 controller 406 periodically queries whether the predefined interval has elapsed in a similar manner as in step 556. If controller 406 determines that the interval has not elapsed, controller returns to step 578 to permit the operator to continue driving tractor 100 along the boundary of the land area. However, if controller 406 has determined that the interval has elapsed, controller 406 continues to step 582 to acquire a current determined location and metadata for reference point 128a, to store the current determined location in memory as an additional boundary point and to map the stored boundary point and metadata on display 408. In step 584, controller 406 queries whether it has received a Save command from Save button 610c. If controller 406 has received a Save command, the controller performs step 586 in which it stops recording the current determined locations of reference points in the second set of boundary points and completes storing boundary points in the second set and replacing all the boundary points in the overwrite set in memory. Thus, on completion of step 586, controller 406 will have stored the first set of boundary points (excluding the deleted overwrite set) and the second set of boundary points in memory 414 and displayed the first and second sets of boundary points on display 408.

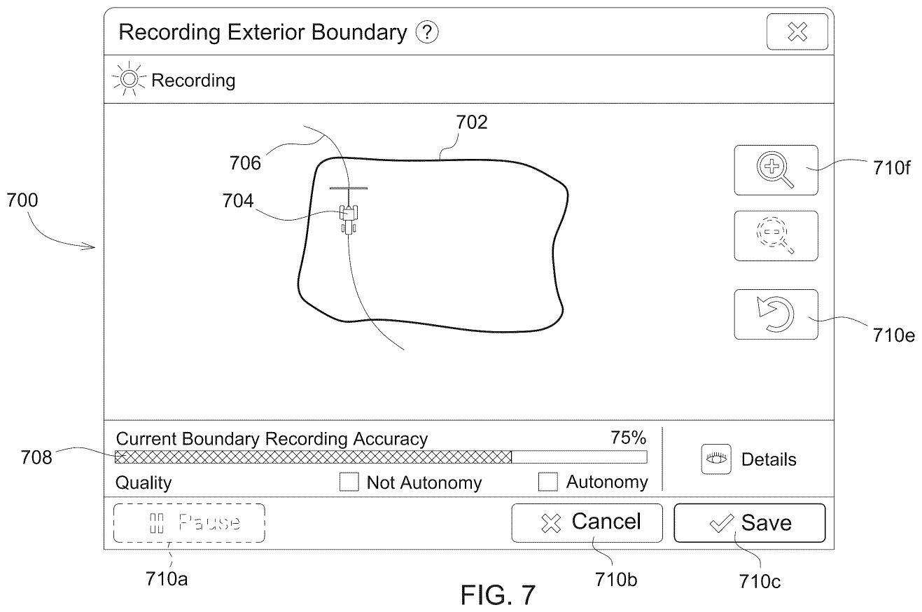

Another embodiment of a system for editing and mapping a boundary or perimeter of an area of land using a vehicle can be configured to edit preexisting maps of the perimeter using newly acquired boundary points. Existing maps can be stored in data files that include a collection of the geographic coordinates and associated metadata of points on the perimeter of an area of land. The metadata can include information regarding the quality, repeatability and accuracy of the position signal or of the geographic coordinates. The metadata can also include information regarding the type of transmitter, receiver, position signal, and algorithms used to calculate the geographic coordinates of each point. A perimeter point represents a set of geographic coordinates for a point on the perimeter as well as its associated metadata. A data file can include a set of perimeter points for all the perimeter points along the perimeter of the land area. Perimeter points can include boundary points previously generated and recorded by tractor 100, or they can be coordinate points and metadata for points generated by other guidance devices and systems. Controller 406 can be configured to receive such data files containing existing maps via cellular telephone networks, Bluetooth networks, and Wi-Fi networks or through data ports connected to controller 406 (such as data ports in operator input interface 410) and to store such files in memory 414. Using operator input interface 410, controller 406 can receive a command to display on display 408 a perimeter line representing an existing set of perimeter points stored in memory 414. Controller 406 can display the perimeter line overlain on a contextual map of the area around tractor 100. As shown in FIG. 7, perimeter line 702 can be a closed shape that represents the perimeter of an area of land.

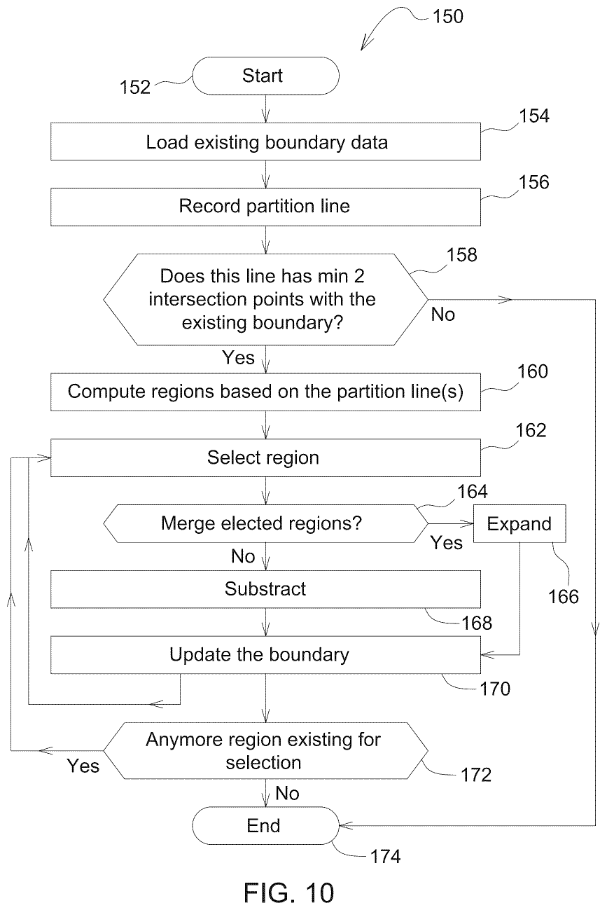

Controller 406 can be configured with programming or code to carry out the steps shown in flowchart 150 of FIG. 10 to edit perimeter line 702 using newly acquired boundary points generated by tractor 100. In step 152, controller 406 can receive a command from input interface 410 to begin editing an existing boundary. In response, controller 406 can present a menu on display 408 enabling an operator to view existing boundaries stored in memory 414 that are nearby to the current location of tractor 100 and to select from among these for editing. In step 154, once the existing boundary is selected, controller 406 can load the relevant perimeter line from memory 414 and display it on display 408 together with the tractor's current location 704 as shown in exemplary image 700 of FIG. 7. Controller 406 can also display interface input devices 412 that include a “Record” button on display 408 to command controller 406 to begin recording boundary points in a similar manner described in FIG. 5A. Preferably, the operator can drive tractor 100 to a starting point of a new track 706 that is to be used to edit existing perimeter line 702 and presses the “Record” button. On receiving the “Record” command, controller 406 in step 156 can begin to perform the steps of the first part of the flow chart 500 to map the path of tractor 100 as the operator drives along track 706. Also, controller 406 in step 406 can display similar Zoom and panning buttons 710f, Undo/Redo buttons 710e, Pause button 710a, Cancel button 710b, and Save button 710c that enable the operator to issue commands to control the mapping process. Optionally controller 406 can be configured to display a separate signal quality bar graph 708 indicating signal quality or boundary point accuracy. When the operator has finished driving new track 706, operator can press Save button 710c to complete mapping or editing the new track. To edit the boundary, operator preferably drives a track 706 that intersects perimeter line 702 in two places and thereby bisects the perimeter line 702 into at least two regions. However, many more closed regions can be created depending on the number of times the operator's driven track intersects perimeter line 702. On receiving the save command, controller 406 completes storing all the boundary points and associated metadata, including the boundary end point of the last current determined location at the end of new track 706 and stops recording.

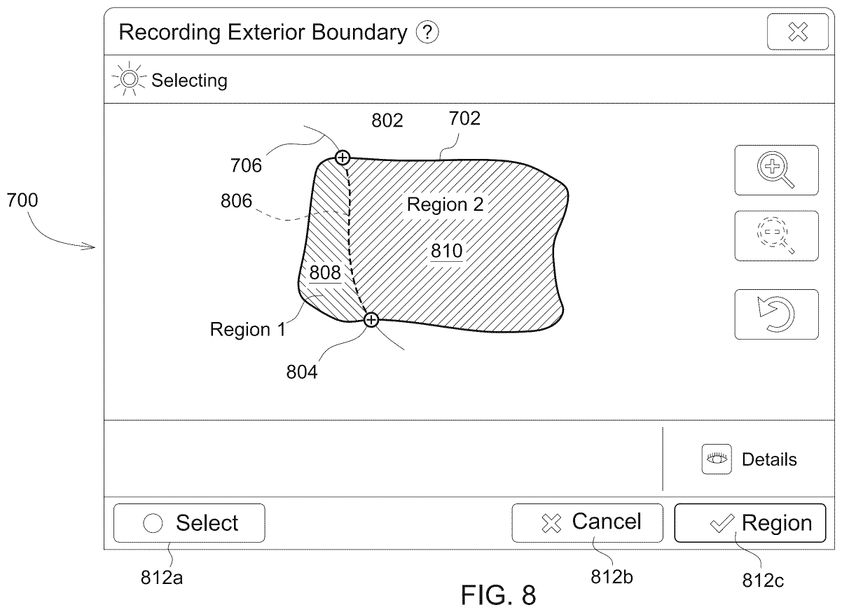

In step 158, controller 406 compares perimeter points in existing perimeter line 702 with the boundary points of new track 706 to identify any intersection points at which perimeter line 702 and new track 706 intersect. If controller 406 fails to identify at least two intersection points, controller proceeds to step 174 and ends. However, if controller 406 identifies at least two intersection points, controller 406 next performs step 160. FIG. 8 illustrates an embodiment in which controller 406 has identified two intersection points, a first intersection point 802 and a second intersection point 804, and also identifies a partition line 806 that separates perimeter line 702 into two regions. A first region is Region1, 808, and a second region is Region2, 810. These are the closed shapes bounded by new track 706 and perimeter line 702. Controller 406 can be configured to identify all the closed shapes bounded by new track 706 and perimeter line 702 so that if it identifies more than two intersection points, controller 406 can identify all the resulting closed regions.

In step 162, controller 406 displays a Select button 812a which issues a command enabling an operator to begin selecting one of the regions 808, 810, a Cancel button 812b which enable an operator to cancel the selection process, and a Save button 812c which enables an operator to save selections. Upon receiving a select command, operator can touch the display 408 to select Region1 808 or Region2 810 as the desired edited boundary. Touching Region1 selects the area bounded by partition line 806 and a portion of existing perimeter line 702 on the edge of Region1 808. Similarly, touching Region2 selects the area bounded by partition line 806 and a portion of existing perimeter line 702 on the edge of Region2 810.

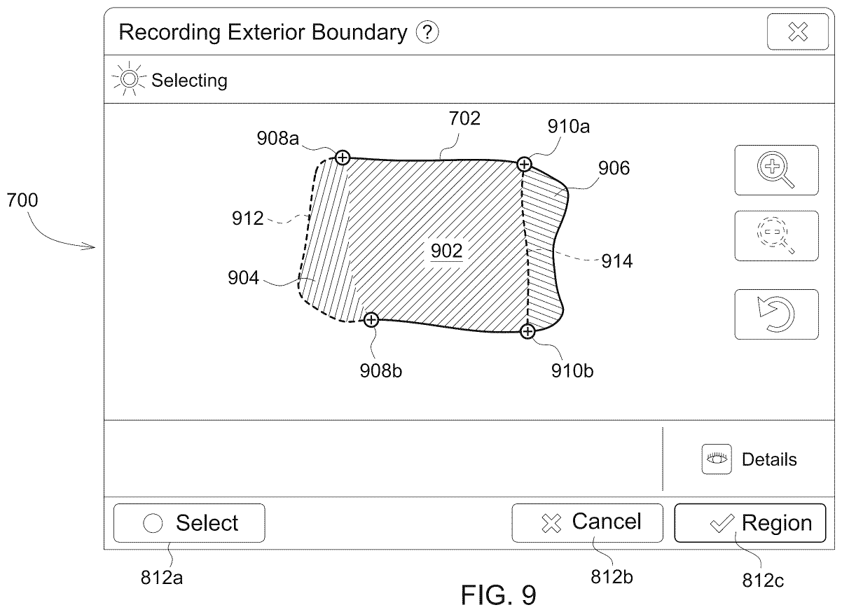

FIG. 9 shows an alternative embodiment in which operator has driven and saved two separate new tracks across perimeter line 702. On receiving a Select command, controller 406 has identified intersection points 908a and 908b that define second partition line 912, and intersection points 910a and 910b that define a third partition line 914. Second partition line 912, third partition line 914, and perimeter line 702 define three different areas—RegionA 902, RegionB 904, and RegionC 906—which provide multiple options for editing the area bounded by existing perimeter ling 702 by adding or subtracting these regions. RegionB 904 is external to and, therefore potentially forms an additional contiguous region that may be added to existing RegionA 902. Accordingly, controller 406 can be configured in step 162 to permit an operator to select multiple regions. In step 164, controller 406 can be configured to provide an option to receive commands via input interface 410 to expand the area of land bounded by existing perimeter line 702 by merging two selected regions or reducing the area of land by subtracting a selected region from the existing perimeter line 702. In addition, in step 164, controller 406 can query whether it has received a command to merge and thereby expand two selected regions. If controller 406 determines it has received such a command, in step 166, it marks the regions to be merged and in step 170 updates the display 408 with the merged boundary. On receiving a save command by a press of Save Region button 812c, controller 406 stores the merged edited boundary in memory 414. If, however, controller 406 determines it has received a command in the negative, in step 168, it marks the regions to be subtracted and in step 170 updates the display 408 with the subtracted boundary. On receiving a save command by a press of Save Region button 812c, controller 406 stores the subtracted edited boundary in memory 414. If, alternatively, controller 406 receives a Cancel command by a press of the cancel button 812b, controller discards the edits. In step 172 controller 406 determines whether there are additional regions that can be selected for editing. If such regions exist, controller 406 returns to step 162, if not, controller 406 ends editing in step 174.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A system for editing and mapping a boundary using a vehicle, the system comprising:
a vehicle configured to traverse a path along a ground surface at a controllable speed and direction, the vehicle having a reference point at a first position and a console configured to receive operator commands to control the speed and direction of the vehicle along the ground surface;
a receiver mounted at a second position on the vehicle, wherein the receiver is configured to receive from each of a plurality of remote wireless transmitters a corresponding position signal, and wherein the receiver is configured to generate a location signal in response to the received corresponding position signals;
a controller having a memory and communicatively coupled to a display, to an input interface, and to the receiver, wherein the controller is configured to,
determine a location of the reference point using the location signal from the receiver and to generate boundary points including an initial boundary point and subsequent boundary points, each subsequent boundary point generated at a predetermined interval following a previous boundary point, wherein each boundary point represents the determined location of the reference point as the vehicle traverses the path,
store a first set of perimeter points in the memory, the first set of perimeter points representing a closed shape of an area of land,
in response to receiving a record command received from the input interface, store a set of boundary points in memory, including the initial boundary point and an end boundary point,
identify a first point of intersection and a second point of intersection between the set of boundary points and the first set of perimeter points, and a set of partition boundary points between the first point of intersection and second point of intersection, and
in response to a select command received from the input interface, store in memory a second set of perimeter points representing points in the first set of perimeter points and the partition boundary points that border a selected region.

2. The system of claim 1, wherein the predetermined interval is a period of less than 0.5 seconds.

3. The system of claim 1, wherein the predetermined interval is a distance of 5 meters or less along the path.

4. The system of claim 1, wherein the controller is configured to display on the display a point representing a current determined location of a position on the vehicle, the first set of perimeter points, and the set of boundary points.

5. The system of claim 1, wherein the controller is configured to display on the display a first region and a second region bounded by the first set of perimeter points and the set of boundary points, and wherein the selected region is either the first region or the second region.

6. The system of claim 5, wherein the set of boundary points bisects the first set of perimeter points.

7. The system of claim 5, wherein the set of boundary points defines an external region contiguous to the region defined by the first set of perimeter points.

8. The system of claim 4, wherein the point representing a determined location of a position on the vehicle is the first position.

9. The system of claim 4, wherein the point representing a determined location of a position on the vehicle is the second position.

10. The system of claim 1, wherein the controller is configured to determine the location of the reference point by calculating a receiver position using the location signal and calculating the location of the reference point by offsetting the receiver position by an offset distance and direction separating the first position from the second position.

11. A method for editing and mapping a boundary using a vehicle, the method comprising:
providing a vehicle configured to traverse a path along a ground surface at a controllable speed and direction, the vehicle having a reference point at a first position and a console configured to receive operator commands to control the speed and direction of the vehicle along the ground surface;
providing a receiver mounted at a second position on the vehicle, wherein the receiver is configured to receive from each of a plurality of remote wireless transmitters a corresponding position signal, and wherein the receiver is configured to generate a location signal in response to the received corresponding position signals;
providing a controller having a memory and communicatively coupled to a display, to an input interface, and to the receiver, wherein the controller is configured to perform steps of,
determining a location of the reference point using the location signal from the receiver and to generate boundary points including an initial boundary point and subsequent boundary points, each subsequent boundary point generated at a predetermined interval following a previous boundary point, wherein each boundary point represents the determined location of the reference point as the vehicle traverses the path,
storing a first set of perimeter points in the memory, the perimeter points representing a closed shape of an area of land,
in response to receiving a record command received from the input interface, storing a set of boundary points in memory, including the initial boundary point and an end boundary point,
identifying a first point of intersection and a second point of intersection between the set of boundary points and the first set of perimeter points, and a set of partition boundary points between the first point of intersection and second point of intersection, and
in response to a select command received from the input interface, storing in memory a second set of perimeter points representing points in the first set of perimeter points and the partition boundary points that border a first selected region.

12. The method of claim 11, wherein the predetermined interval is a period of less than 0.5 seconds.

13. The method of claim 11, wherein the predetermined interval is a distance along a path traversed by the vehicle of 5 meters or less.

14. The method of claim 11, wherein the controller is configured to display on the display a first region and a second region bounded by the first set of perimeter points and the set of boundary points, and wherein the selected region is either the first region or the second region.

15. A system for editing and mapping a boundary using a vehicle, the system comprising:
a vehicle configured to traverse a path along a ground surface at a controllable speed and direction, the vehicle having a reference point at a first position and a console configured to receive operator commands to control the speed and direction of the vehicle along the ground surface;
a receiver mounted at a second position on the vehicle, wherein the receiver is configured to receive from each of a plurality of remote wireless transmitters a corresponding position signal, and wherein the receiver is configured to generate a location signal in response to the received corresponding position signals;
a controller having a memory and communicatively coupled to a display, to an input interface, and to the receiver, wherein the controller is configured to,
determine a location of the reference point using the location signal from the receiver and to generate boundary points including an initial boundary point and subsequent boundary points, each subsequent boundary point generated at a predetermined interval following a previous boundary point, wherein each boundary point represents the determined location of the reference point as the vehicle traverses the path,
store a set of perimeter points in the memory, and
in response to receiving a record command received from the input interface, replace in memory a plurality of perimeter points in the set of perimeter points with a plurality of generated boundary points.
